(19) United States
(12) Patent Application Publication
(10) Pub. No.: US 2004/0004972 A1
(43) Pub. Date: Jan. 8, 2004

(54) Method and apparatus for improving data transfer scheduling of a network processor

(76) Inventors: Sridhar Lakshmanamurthy, Sunnyvale, CA (US); Lawrence B. Huston, Wexford, PA (US); Debra Bernstein, Sudbury, MA (US); Gilbert M. Wolrich, Framingham, MA (US); Uday Naik, Fremont, CA (US)

Correspondence Address: KENYON & KENYON, Suite 600, 333 W. San Carlos, Street, San Jose, CA, 95110-2711, US

(21) Appl. No.: 10/188,877

(22) Filed: Jul. 3, 2002

(51) Int. Cl. H04L 12/28

(52) U.S. Cl. 370/413; 370/419

(57) ABSTRACT

A method and apparatus for improving data transfer scheduling of a network processor given communication limitations between network processing engines by providing an improved scheduling scheme is described.

### BACKGROUND INFORMATION

The present invention relates to network processors. More specifically, the present invention relates to a system for improving data transfer scheduling of a network processor given communication limitations between network processing engines by providing an improved scheduling scheme.

FIG. 1 provides a typical configuration of a computer network. In this example, a plurality of computer systems 102 are connected to and are able to communicate with each other, as well as the Internet 104. The computer systems are linked to each other and, in this example, the Internet by a device such as a router 106. The computer systems 102 communicate with each other using any of various communication protocols, such as Ethernet, IEEE 802.3 (Institute of Electrical and Electronics Engineers 802.3 Working Group, 2002), token ring, and Asynchronous Transfer Mode (ATM; Multiprotocol Over ATM, Version 1.0, July 1998). Routers 106, among other things, insure sets of data go to their correct destinations. Routers 106 utilize network processors (not shown), which perform various functions in the transmission of network data, including data encryption, error detection, and the like.

As flow rates improve for network devices, it is necessary to eliminate bottlenecks adversely affecting overall network flow. To this end, optimization of data transfer scheduling is important in maximizing resource utilization. Due to communication limitations of network processing engines (discussed below), it is desirable to have an improved system for data transfer scheduling.

### BRIEF DESCRIPTION OF THE DRAWINGS

FIG. 1 provides a typical configuration of a computer network.

FIG. 2 provides a block diagram of a processing system according to an embodiment of the present invention.

FIG. 3 provides an illustration of a network router according to an embodiment of the present invention.

FIG. 4 provides a block diagram of the queuing scheme of a line card in a network router according to an embodiment of the present invention.

FIG. 5 provides a block diagram illustrating processing engines (micro-engines) of the egress processor according to an embodiment of the present invention.

FIG. 6 provides a flowchart, describing the process of data transfer scheduling via Deficit Round Robin (DRR).

FIGS. 7a and 7b illustrate the process of data transfer scheduling via Deficit Round Robin (DRR) of an exemplary set of queues by showing the first four stages in the process.

FIG. 8 provides a flowchart illustrating the steps of data transmission scheduling according to an embodiment of the present invention.

FIGS. 9a, 9b, and 9c illustrate the process of data transfer scheduling according to an embodiment of the present invention.

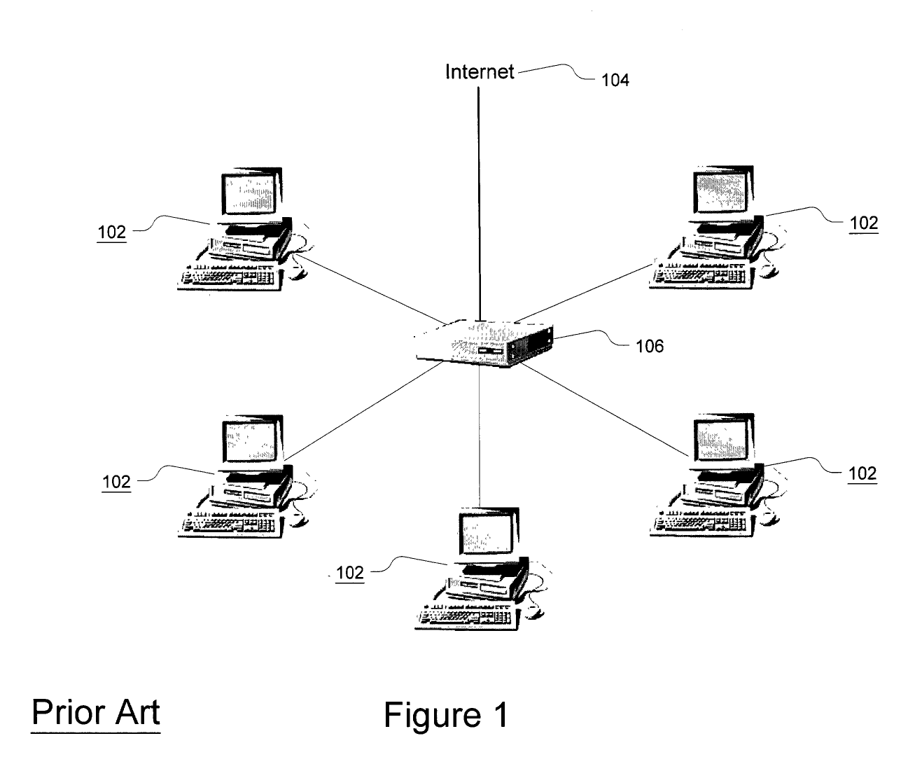

### DETAILED DESCRIPTION

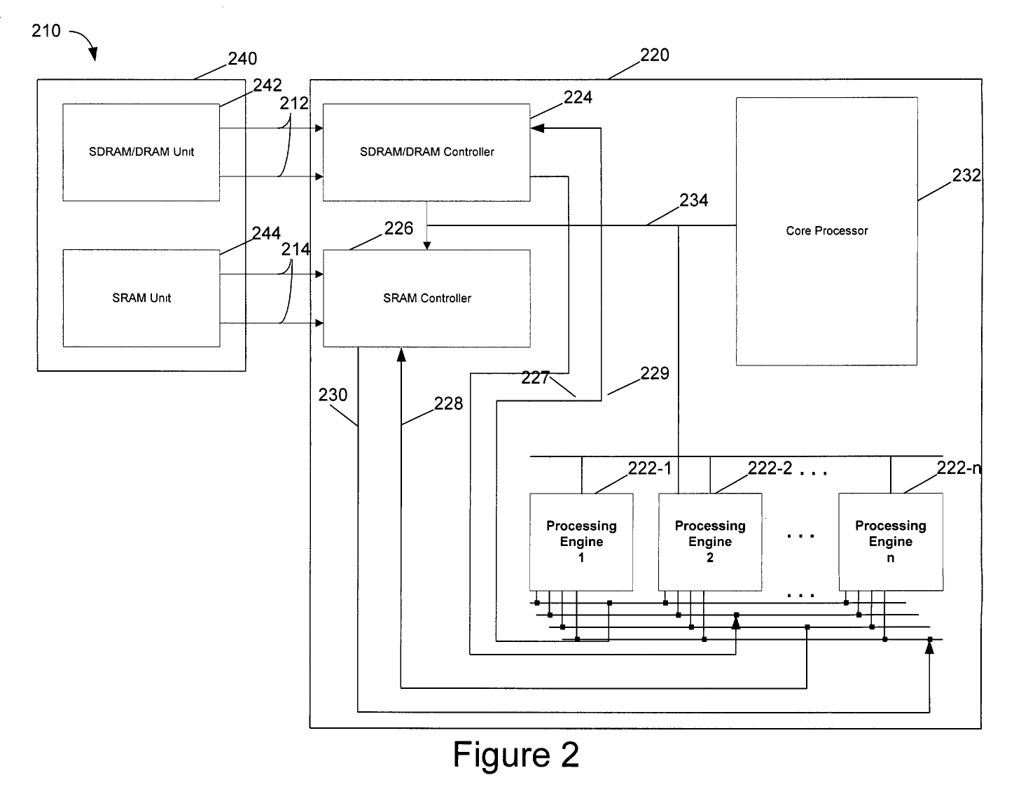

A method and apparatus for improving data transfer scheduling of a network processor given communication limitations between network processing engines is described. FIG. 2 provides a block diagram of a processing system according to an embodiment of the present invention. In this embodiment, a processor system 210 includes a parallel, hardware-based multithreaded network processor 220, coupled by a pair of memory buses 212, 214 to a memory system or memory resource 240. The memory system 240 includes a dynamic random access memory (DRAM) unit 242 and a static random access memory (SRAM) unit 244. In this embodiment, the processor system 210 is useful for tasks that can be broken into parallel subtasks or functions. The hardware-based multithreaded processor 220 may have multiple processing engines (micro-engines) 222-1-222-n, each with multiple hardware-controlled threads that may be simultaneously active.

In this embodiment, processing engines 222-1-222-n maintain program counters and their respective states in hardware. Effectively, corresponding sets of contexts or threads can be simultaneously active on each of processing engines 222-1-222-n while only one processing engine may be actually operating at a given time.

In this embodiment, eight processing engines 222-1-222-n, where n=8, are implemented, the processing engines 222-1-222-n having the ability for processing eight hardware threads or contexts. The eight processing engines 222-1-222-n operate with shared resources, including memory resource 240 and bus interfaces. In this embodiment, the hardware-based multithreaded processor 220 includes a dynamic random access memory (DRAM)/static DRAM (SDRAM/DRAM) controller 224 and a static random access memory (SRAM) controller 226. The SDRAM/DRAM unit 242 and SDRAM/DRAM controller 224 may be used for processing large volumes of data, such as the processing of network payloads from network packets. The SRAM unit 244 and SRAM controller 226 may be used in a networking implementation for low latency, fast access tasks, such as accessing look-up tables, core processor memory, and the like.

In accordance with an embodiment of the present invention, push buses 227, 228 and pull buses 229, 230 are used to transfer data between processing engines 222-1-222-n and SDRAM/DRAM unit 242 and SRAM unit 244. In particular, push buses 227, 228 may be unidirectional buses that move the data from memory resource 240 to processing engines 222-1222-n whereas pull buses 229, 230 move data from processing engines 222-1-222-n to their associated SDRAM/DRAM unit 242 and SRAM unit 244 in memory resource 240.

In accordance with an embodiment of the present invention, eight processing engines 222-1-222-8 may access either SDRAM/DRAM unit 242 or SRAM unit 244 based on characteristics of the data. Thus, low latency, low bandwidth data may be stored in and fetched from SRAM unit 244, whereas higher bandwidth data for which latency is not as important, may be stored in and fetched from SDRAM/DRAM unit 242. Processing engines 222-1-222-8 may execute memory reference instructions to either SDRAM/DRAM controller 224 or SRAM controller 226.

In accordance with an embodiment of the present invention, the hardware-based multithreaded processor 220 also may include a core processor 232 for loading micro-code control for other resources of the hardware-based multithreaded processor 220. In this example, core processor 232 may have an XScale™-based architecture manufactured by Intel Corporation of Santa Clara, Calif. Core processor 232 may be coupled by a processor bus 234 to DRAM unit 224 and SRAM unit 226.

In one embodiment, the core processor 232 performs general functions such as handling protocols, exceptions, and extra support for packet processing where processing engines 222-1-222-n may pass the packets off for more processing. The core processor 232 also executes an operating system (OS). Through the OS, core processor 232 may call functions to operate on processing engines 222-1-222-n. Core processor 232 may use any supported OS, such as, a real time OS. In an embodiment of the present invention, core processor 232 may be implemented as an XScale™ architecture, using, for example, operating systems such as the Windows® NT real-time operating system from Microsoft Corporation of Redmond, Wash.; VXWorks® operating system from Wind River International of Alameda, Calif.; IC/OS operating system, from Micrium, Inc. of Weston, Fla., etc.

Advantages of hardware multithreading may be explained in relation to SRAM or SDRAM/DRAM accesses. As an example, an SRAM access requested by a context (that is, a thread, from one of processing engines 222-1-222-n) may cause SRAM controller 226 to initiate an access to SRAM unit 244. SRAM controller 226 may access SRAM memory unit 226, fetch the data from SRAM unit 226, and return data to the requesting programming engine 222-1-222-n.

During an SRAM access, if one of the processing engines 222-1-222-n had only a single thread that could operate, that one processing engine would be dormant until data was returned from the SRAM unit 244.

By employing hardware context swapping within each of processing engines 222-1-222n the hardware context swapping may enable other contexts with unique program counters to execute in that same engine. Thus, a second thread may operate while the first awaits the read data to return. During execution, the second thread accesses SDRAM/DRAM unit 242. In an embodiment, while the second thread operates on SDRAM/DRAM unit 242, and the first thread operates on SRAM unit 244, a third thread, also operates in a third of processing engines 222-1222-n. The third thread operates for a certain amount of time until it needs to access memory or perform some other long latency operation, such as making an access to a bus interface. Therefore, processor 220 may have simultaneously executing bus, SRAM and SDRAM/DRAM operations that are all being completed or operated upon by one of processing engines 222-1-222-n and have more than one thread available to process work.

The hardware context swapping may also synchronize completion of tasks. For example, if two threads hit a shared memory resource, such as the SRAM memory unit 244, each one of the separate functional units, such as the SRAM controller 226 and SDRAM/DRAM controller 224, may report back a flag signaling completion of an operation upon completion of a requested task from one of the processing engine threads or contexts. Once the processing engine executing the requesting thread receives the flag, the processing engine determines which thread to turn on.

In an embodiment of the present invention, the hardware-based multithreaded processor 220 may be used as a network processor. As a network processor, hardware-based multithreaded processor 220 may interface to network devices such as a Media Access Control (MAC) device, such as a 10/100BaseT Octal MAC (Institute of Electrical and Electronics Engineers, IEEE 802.3) or a Gigabit Ethernet device (Gigabit Ethernet Alliance, 1998) (not shown). In general, as a network processor, the hardware-based multithreaded processor 220 may interface to any type of communication device or interface that receives or sends a large amount of data. Similarly, in an embodiment, the processor system 210 may function in a networking application to receive network packets and process those packets in a parallel manner.

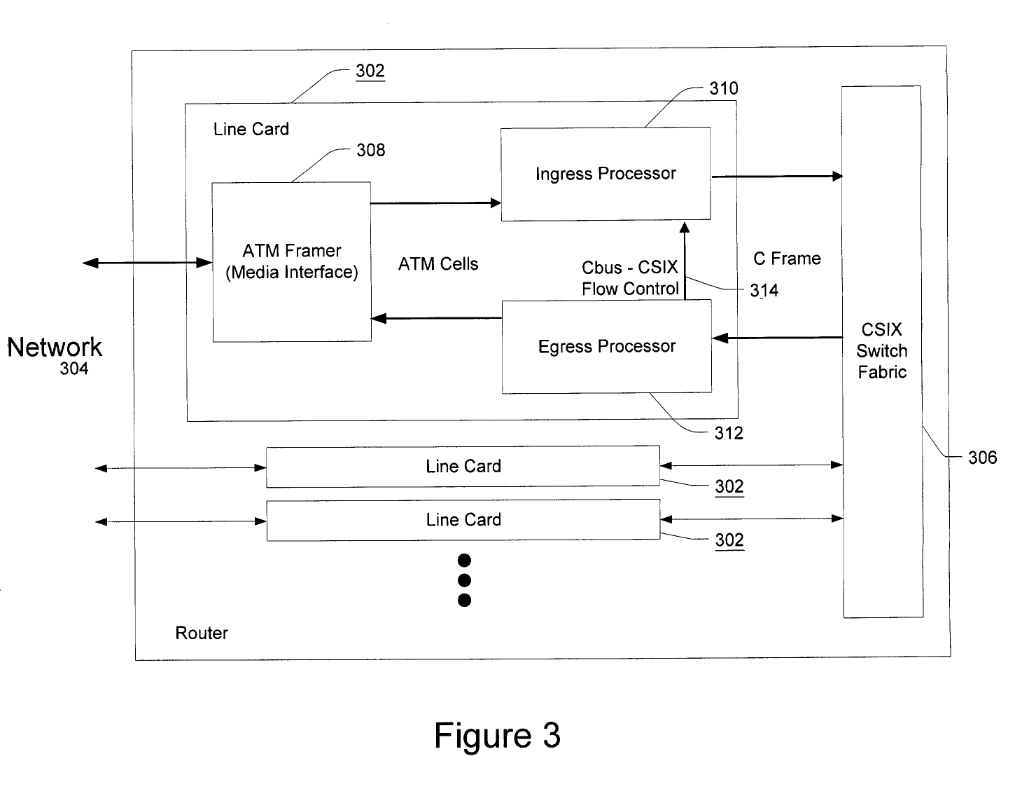

FIG. 3 provides an illustration of a network router operating according to an embodiment of the present invention. In one embodiment, a line card 302 is used to process data on a network line. Each line card acts as an interface between a network 304 and a switching fabric 306. The line card 302 receives a data set from the network 304 via a framer (media interface) 308. In an embodiment, the framer 308 converts the data set from the format used by the network 304 to a format for processing, such as from Internet Protocol (IP) to Asynchronous Transfer Mode (ATM). This conversion may include segmenting the data set (as described below). The converted (translated) data set is transmitted from the framer 308 to an ingress processor 310 (see 210 of FIG. 2). The ingress processor 310 performs necessary processing on the data set before being forwarded to the switching fabric 306. This processing may include further translation, encryption, error checking, and the like. After processing, the ingress processor 310 converts the data set into a transmission format for the switching fabric 306, such as the common switch interface (CSIX) protocol (Common Switch Interface Specification-L1, August 2000) then transmits the data set to the switching fabric 306.

In an embodiment, the line card 302 also provides transmission of a data set from the switching fabric 306 to the network 304. An egress processor 312 (see 210 of FIG. 2) receives a data set from the switching fabric 306, processes the data set, and transmits the data set to the framer 308 for protocol conversion in preparation for transmission over the network 304.

In one embodiment, a CSIX bus (CBUS) 314 carries flow control information from the egress processor 312 to the ingress processor 310. CSIX link level or fabric level flow control messages that originate in either the switch fabric 306 or the egress processor 312 are transmitted over the CBUS.

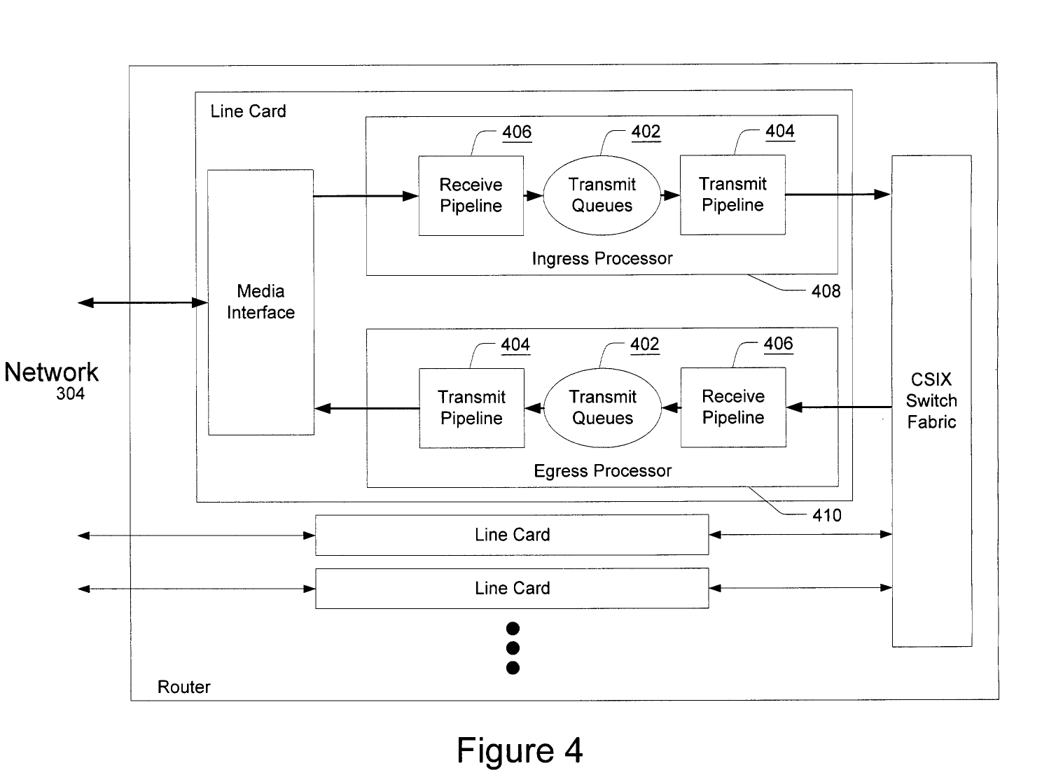

FIG. 4 provides a block diagram of the queuing scheme of a line card in a network router according to an embodiment of the present invention. In an embodiment, data set is placed in a transmit queue 402 before proceeding from the receive pipeline 406 to the transmit pipeline 404 of the ingress 408 or egress 410 processor. The transmit queues 402 operate as buffers to accommodate changes in flow conditions for the processors.

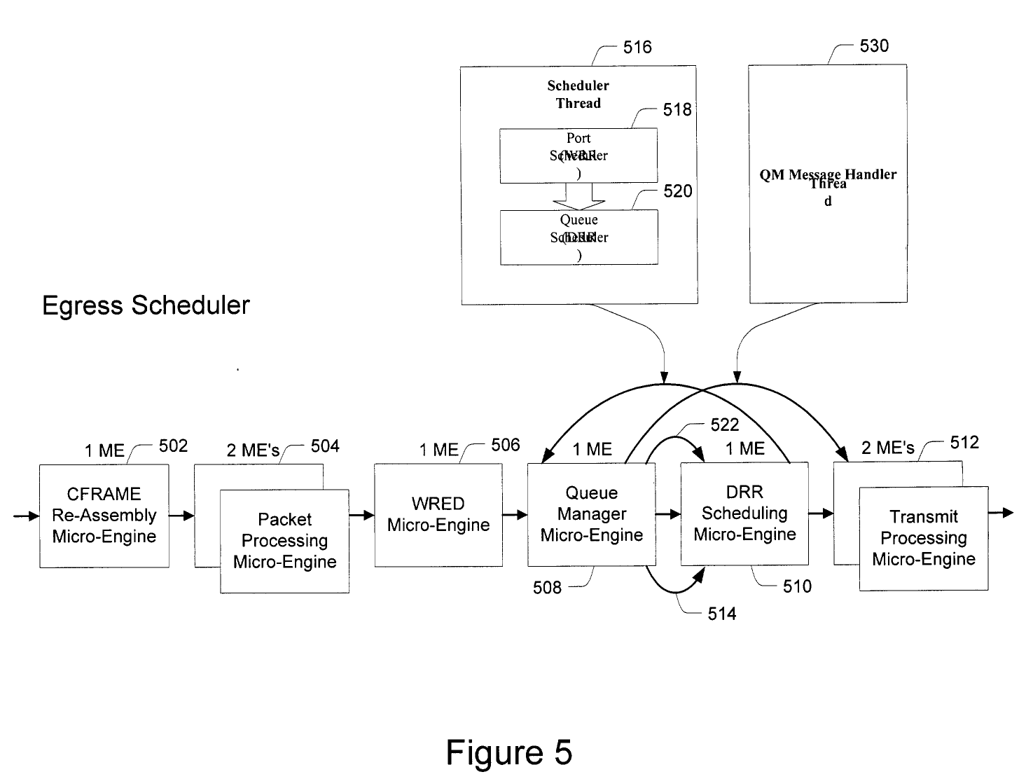

FIG. 5 provides a block diagram illustrating processing engines (micro-engines) of the egress processor according to an embodiment of the present invention. In one embodiment, a data sets of a protocol such as POS (Packet Over SONET (Synchronous Optical Network; SONET Interoperability Forum, 1994)) are received from the fabric (not shown) and reassembled 502. In this embodiment, an amount of packet processing 504 (e.g., packet reclassification) is performed on the re-assembled packets. Further, congestion management using techniques such as Weighted Random Early Detection (WRED) 506 is performed. In an embodiment, data sets are passed to a queue manager 508 and held until approved for transmission 512 by a scheduling micro-engine (ME) 510.

To implement standard deficit round robin (DRR) scheduling, the scheduler would need to know the packet size of a packet (data set) at the head of a queue (as explained below). In this example, the Queue Manager (QM) 508 may return this to the scheduler 510 via communication such as by a next neighbor (NN) ring, but since the QM 508 runs on a separate micro-engine, there is a relatively large latency in returning this information to the scheduler 510. In this embodiment, a modified DRR algorithm is used to overcome this latency problem.

To schedule 510 a queue, the scheduler needs to know which queues (not shown) have data. The QM 508 sends queue transition messages 514 to the scheduler 510, which indicate when a queue goes from empty to non-empty and vice versa. The latency associated with sending these messages from the QM 508 to the scheduler 510 may cause problems with scheduling data transfer, as discussed below.

In one embodiment, the egress scheduler operates on a single micro-engine and has two threads, a scheduler thread 516 and a QM message handler thread 530. The two share data structures stored in local memory and global (absolute) registers (not shown). In an embodiment, the scheduler thread 516 is responsible for actually scheduling a queue and sending a dequeue request to the QM micro-engine 508 (asking to send the lead packet from queue to local memory). In an embodiment, the thread 516 runs a port scheduler 518 and a queue scheduler 520. The port scheduler performs Weighted Round Robin (WRR) scheduling on the ports and finds a schedulable port that has at least one queue with data (discussed below). The queue scheduler 520 performs (modified) DRR scheduling on the queues within the chosen port and finds a schedulable queue that has data. In one embodiment, both schedulers use bit vectors to maintain information about which ports/queues have data and credit. Once the eligible queue is found, a dequeue request is sent by the scheduler thread 516 to the QM 508 (to move the lead packet to local memory).

In one embodiment, the QM message handler thread 530 takes messages coming back from the QM micro-engine 508. The QM micro-engine receives dequeue requests from the scheduler 510. For each request, it sends a transmit message to the TX (transmit) micro-engine 512 and a dequeue response 522 to the scheduler 510. This response 522, which may be transmitted over a next neighbor (NN) ring, has the length of the packet dequeued and an indication of whether the queue went from non-empty to empty (dequeue transition). If the scheduler 510 issued a dequeue to a queue that had no data, then in this example, the packet length returned will be 0. The QM 508 may also send an enqueue transition message to the scheduler 510 when a queue goes from non-empty to empty. In an embodiment, this thread 530 updates the bit vectors for credit and data based on the messages received from the QM 508.

In an embodiment, the scheduler 510 sends 516 one word (e.g., 32 bits) to the QM 508 for every dequeue request. This word contains the queue identification (ID), consisting of a port number (4 bits) and a queue number within the port (3 bits).

In an embodiment, the scheduler 510 keeps track of the number of packets it has scheduled per port. The transmit micro-engine 512 provides information to the scheduler 510 as to how many packets were transmitted. The scheduler 510 uses this to determine the number of packets in flight for any given port. If the number of packets in flight for a given port exceeds a pre-computed threshold, then the port is no longer scheduled until some packets are transmitted. In an embodiment, the transmit micro-engine 512 communicates the number of packets transmitted per port to sixteen transfer registers (one per port) in the scheduler 510.

An Xscale™ architecture specifies the credit information for each queue and the weight for each port. In an embodiment, this is done via a control block (not shown) shared between the Xscale™ processor and the scheduler micro-engine 510.

As explained below, in an embodiment, the packet size is not available for a queue when it is being scheduled. Once the dequeue is issued, the packet size is received N beats later, where each beat is 88 cycles (typically N=8 beats). In one embodiment, a ‘beat’ is the minimum clock budget per pipeline stage, as determined by the packet arrival rate and the minimum packet size. In an embodiment, a scheme of negative credits is utilized (as explained below). The criteria for a queue to be eligible to send is that it has data, flow control is off on the port and the credits for the queue are positive (explained below). A packet is transmitted from a queue if it meets the above criteria. Once the packet length is received, (N beats later), the packet length is decremented from the current credit of the queue. When the current credit of the queue goes negative, it can no longer transmit. When all the queues on a port go negative, one DRR round is over. Each queue gets another round of credit at this point. To ensure that all the queues are schedulable with one round of credit, the minimum quantum (allocation) for a queue is kept as (N*MTU)/CHUNK_SIZE. (‘N’=Number of Beats; ‘MTU’=Maximum Transmission Unit; Packet size is provided in multiples of ‘CHUNK_SIZE’).

The bit vector with information on which queues have data may not be current. This could mean that a dequeue is issued on a queue that has no data. In an embodiment, if a dequeue instruction is issued on a queue that has no data, the QM 508 returns the packet size as 0. This is treated as a special case. The scheduler will run slightly faster than the QM to allow it to make up for lost slots. The queue is not penalized in scheduling because no credit is decremented for the invalid dequeue.

In an embodiment, the scheduler schedules a packet every beat (e.g., 88 cycles). This means that for large packets, the scheduler 510 is running faster than the transmit micro-engine 512. In an embodiment, if the queue between TX 512 and QM 508 gets full due to large packets or because the scheduler 510 is running slightly faster, the QM 508 will not dequeue the packet and instead, will return a 0 for the packet size.

In one possible embodiment, the algorithm will round robin among ports first and queues (within ports) next. For example, if queue i of port j is scheduled, the next queue scheduled will be queue k of port j+1. When the scheduler comes back to port j, the next queue scheduled in port j will be queue i+1. This increases the probability that the packet length is back by the time the queue is returned to since there is a finite latency to return back to the same port.

In an embodiment, while a queue is empty or flow control is on, its credit remains untouched. If a queue transitions from being empty to having data in the middle of a round, it is evaluated (and/or acted upon) during that round with the available credit. Another alternative would be to not let the queue participate until the end of the DRR round, but such an alternative may not work well in this algorithm since a high value has been set for the credit increment and the rounds are fairly long.

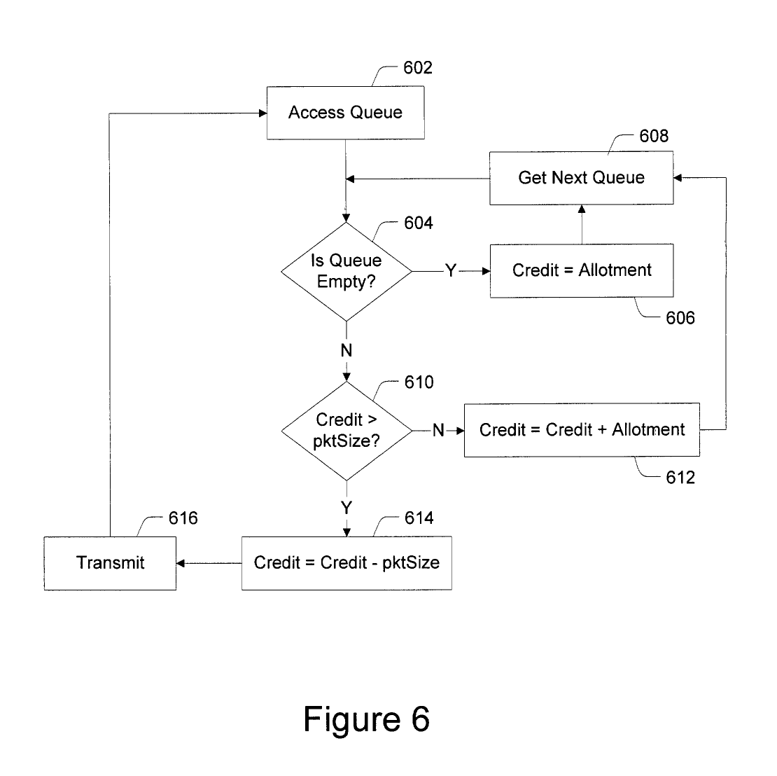

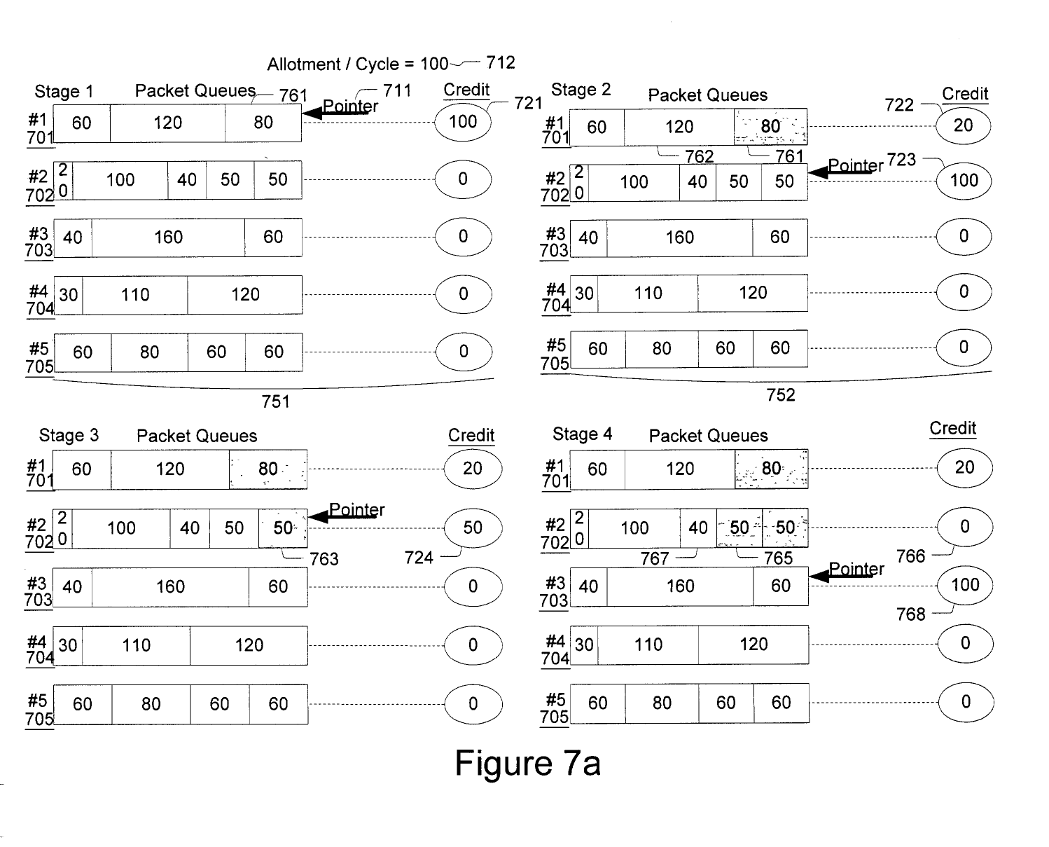

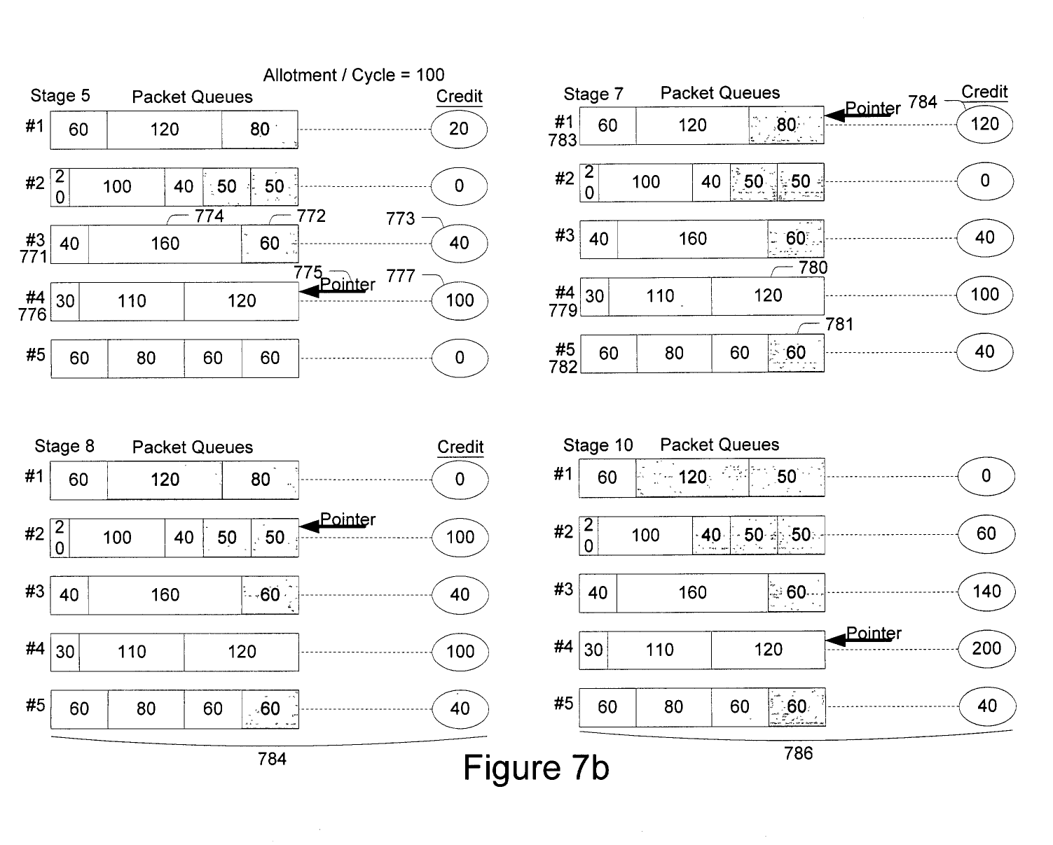

FIG. 6 provides a flowchart, describing the process of data transfer scheduling via Deficit Round Robin (DRR). A queue in a set of queues is accessed 602 to see if the queue has data 604. If the queue is empty, a credit value associated to that queue is reset to an allotment value 606. Then, the system moves to the next queue 608 in the set of queues (by a Round Robin cycle, such as is shown in FIGS. 7a and 7b) and repeats the process. If the queue has data 604, the system determines 610 whether the current credit value associated to that queue is greater than the size of the data set (packet) requested to be transmitted. If not, the credit value is increased by the allotment value 612 so that the data set might be able to be transmitted on the next round (as shown in FIGS. 7a and 7b). If the current credit value associated to the queue is greater than the size of the data set requested on the queue, the data set (packet) size is subtracted from the credit value 614, and the data set is transmitted 616. As shown in FIGS. 7a and 7b, it is possible for more data sets from the same queue to be transmitted before the system looks at another queue if the credit started high enough and/or the packet sizes were small enough (as shown in FIGS. 7a and 7b).

FIG. 7a illustrates the process of data transfer scheduling via Deficit Round Robin (DRR) of an exemplary set of queues by showing the first four stages in the process. Five queues are being scheduled, each with multiple, varying sized data sets (packets). In the first stage 751, a pointer 711 selects the first queue 701 for the system to evaluate. An allotment of 100 712, for example, is provided to the credit value 721 associated to the first queue 701. By stage two 752, the top priority (by First In, First Out priority, etc.) packet is transmitted because a credit value 721 of 100 is greater than a packet size 761 of 80. Because 100−80=20, the credit value 722 of the first queue 701 is now 20. Also, by stage two 752, the pointer has moved to the second queue 702 and an allotment is given to its credit value 723 because the size of the next packet 762 in the first queue is greater than the available credit (120>20), and thus, a data set transfer is not allowed from this queue in this round.

By stage 3, the first packet 763 (size=50) is transmitted because 100>50, and 50(packet size) is subtracted from 100 (credit value) to yield the new credit value (50) 724. By stage 4, another packet 765 has been transmitted from the second queue 702, dropping the credit value 766 to 0 (50−50=0). Because 40>0, the next packet 767 may not be transmitted this round. Therefore, the pointer has been moved to the third queue 703 and an allotment is given to its credit 768.

FIG. 7b provides a continued illustration from FIG. 7a of data transfer scheduling via Deficit Round Robin (DRR). By stage 5, the first packet 772 of the fifth queue 771 has been transmitted and the associated credit 773 has been adjusted to 40, but the next packet was not transmitted because its size (160) 774 is greater than the credit (40) 773. The pointer 775 is adjusted to the next queue 776, and its credit 777 gets allocation.

Skipping ahead two stages, by stage 7 the system has determined that the first packet 780 of the fourth queue 779 could not be transmitted because its size was greater than the available credit (120>100). Then, the first packet 781 of the fifth queue 782 was transmitted and the first round ended. The pointer then moved to the first queue 783, and the allocation value (100) was added to the associated credit (20) to yield the new credit value (120) 784. This process continues in a similar manner through other following stages as illustrated 784,786.

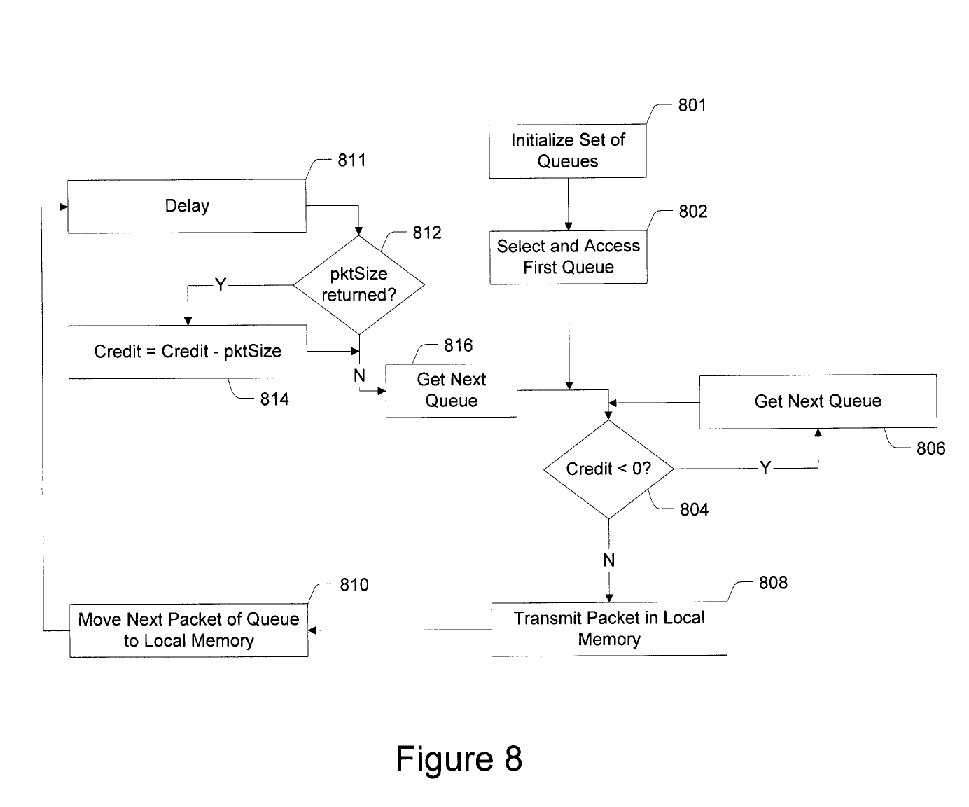

FIG. 8 provides a flowchart illustrating the steps of data transmission scheduling according to an embodiment of the present invention. A difficulty exists in utilizing a scheduling scheme such as DRR in situations where latency of packet size knowledge is substantial. A modified scheme is necessary. In one embodiment, each queue is initialized 801 by accrediting it with a (beginning) allotment of credit and moving its proximate packet (determined by FIFO, etc.) to local memory. Then, an individual queue is selected and accessed 802. In one embodiment, it is then determined 804 whether the credit value associated to the queue is negative. If so, the next queue is accessed 806 and evaluated for credit negativity 804. Upon finding 804 a queue with a non-negative credit value, the packet stored in local memory is transmitted 808, and the next packet to be transmitted is moved to local memory 810.

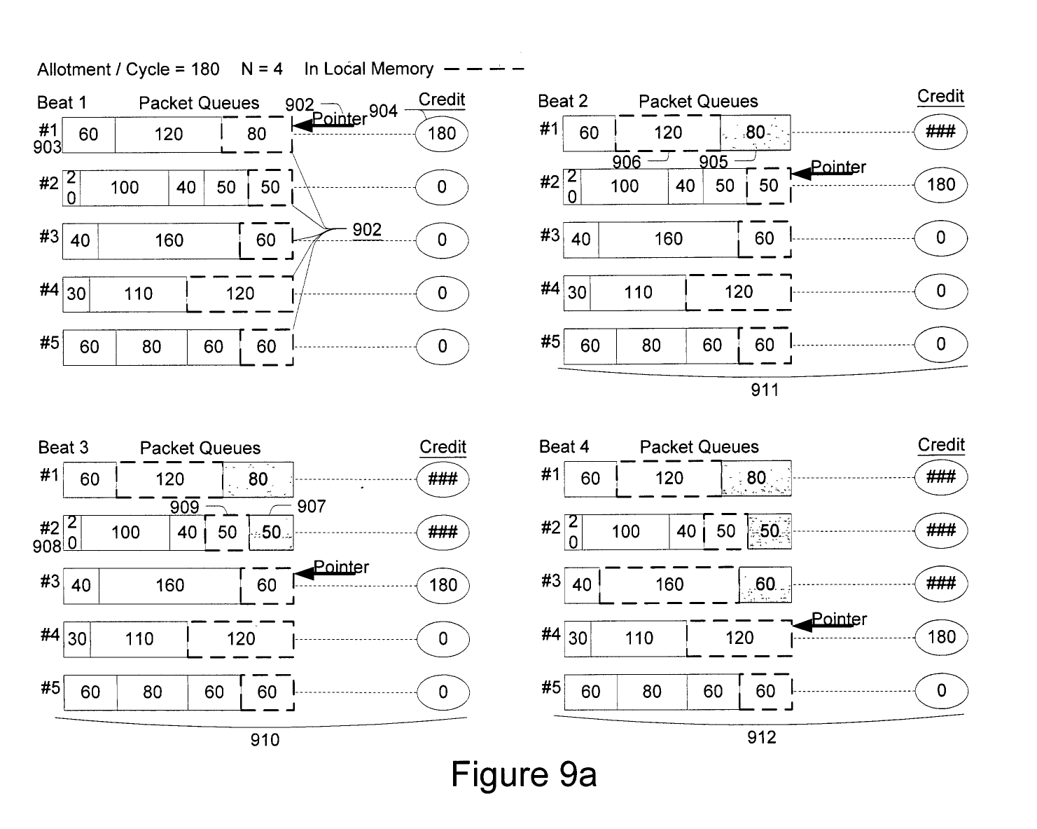

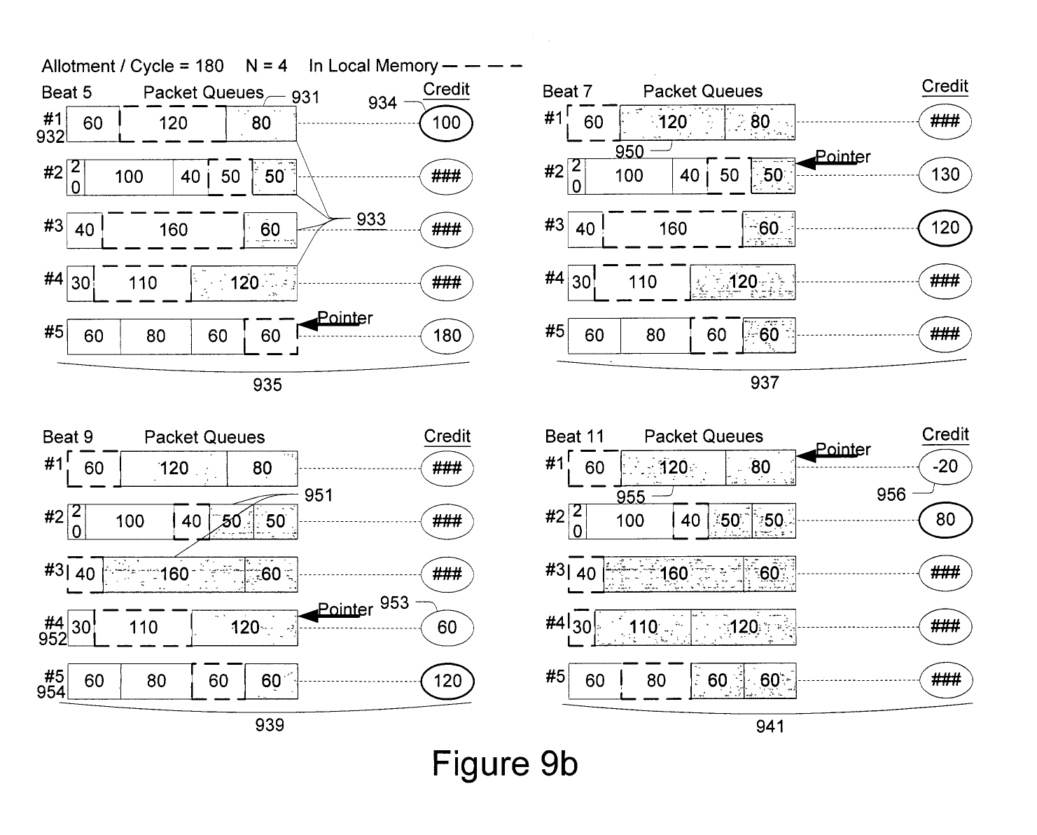

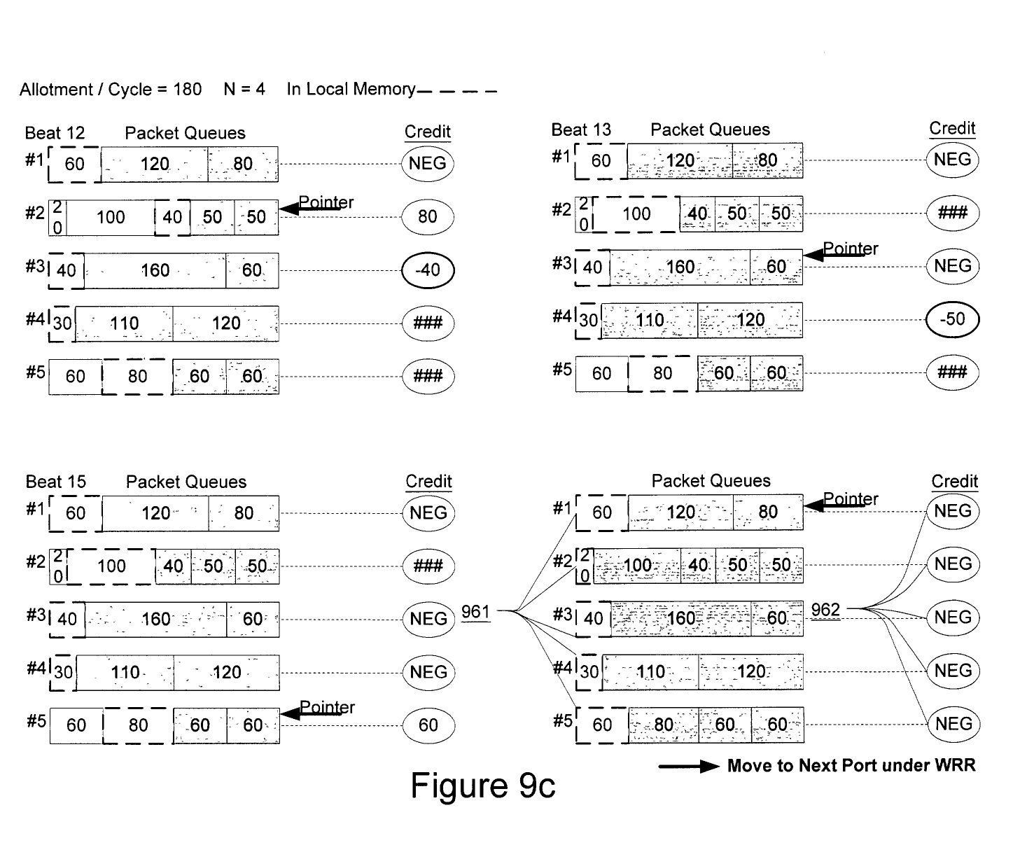

In one embodiment, it is determined 812 after an amount of time 811 whether the size of the packet has been received by the DRR Scheduling ME 510 from the Queue Manager ME 508. (See FIG. 5). (As stated above, there is an amount of delay 811 between a packet being moved to local memory/being transmitted and the DRR Scheduling ME 510 (see FIG. 5) finding out the packet's size.) In one embodiment, once the packet size is received (either this round or later), the credit value is decremented by the packet size 814, as is illustrated in FIGS. 9a-9c. In one embodiment, the next queue is accessed 816, and the process is continued.

In one embodiment, this scheme of data transfer scheduling is performed on a set of queues of a virtual port, which may be one of a plurality of virtual ports. The scheduling process for the port's queues will continue until each queue's credit value is negative. At this time, in one embodiment, another port is selected by a scheduling scheme, such as weighted round robin (WRR). In one embodiment, the queues of the next port are scheduled similarly. This process may be continued until all ports have been scheduled, at which time the process starts over.

FIG. 9a illustrates the process of data transfer scheduling according to an embodiment of the present invention. As stated above, a difficulty exists in utilizing a scheduling scheme such as DRR in situations where latency of packet size knowledge is substantial. In one embodiment of the present invention, the proximate (via FIFO (First In, First Out buffer), etc.) packet of each queue is placed in local memory 901 for transmission. As stated, packets are scheduled to be sent one per beat (equals 88 cycles, in an embodiment). N represents the latency for packet size knowledge, i.e. how many beats before the scheduler knows a packet's size (for credit adjustment). In one embodiment, N=8 beats. However, for simplification of illustration purposes N=4 is utilized.

In an embodiment, the pointer 902 indicates the first queue 903, and its associated credit value 804 is adjusted by the allocation value, which equals 180 in this example. As stated above, in an embodiment the system determines whether the credit is non-negative to decide if the packet in local memory can be transmitted. Because the credit (180) 904 was non-negative, the packet in local memory 905 is transmitted by the second beat 911. The next packet 906 (for transmission) in the first queue is placed in local memory, and the pointer moves to the second queue. In an embodiment, this is done regardless of the size of packet in the local memory (because the scheduler does not know its size yet). By the third beat 910, the packet 907 in local memory for the second queue 908 has been transmitted because its credit (180) was non-negative, and the next packet 909 was placed in local memory. This process continues similarly through the fourth beat 912.

FIG. 9b provides a continued illustration from FIG. 9a of data transfer scheduling according to an embodiment of the present invention. In an embodiment, by the fifth beat 935 each packet in the local memories for the first four queues 933 has been transmitted (because their credit values were all non-negative)) and the packet size (80) of the first packet 931 sent from the first queue has finally arrived (N=4 beat latency) at the scheduler (not shown). This value (80) can now be used to adjust the credit value 934 to equal 100 (180−80=100).

Skipping to the seventh beat 937, a cycle (round) has been completed and the next packet 950 of the first queue has been transmitted. This transmission was allowed even though the packet size (120) was greater than the available credit (100). The fact that the credit was non-negative is all that matters. As stated, in an embodiment, the scheduler does not know the size of the packet in local memory until it is too late to compare it to the current credit.

Skipping to the ninth beat 939, more packets 951 have been transmitted. Further, the credit counter (60) 953 was updated for the fourth queue 952 at the eighth beat (not shown) and for the fifth queue 954 by the ninth beat 939. By the eleventh beat 941, the size of the first queue's second packet 955 has arrived (in the tenth beat) and has been deducted from the credit 956, yielding a negative value (−20). Because the credit value 956 of this queue is now negative, no more transmissions can occur from this queue.

FIG. 9c provides a continued illustration from FIG. 9b of data transfer scheduling according to an embodiment of the present invention. In one embodiment, the process illustrated in FIGS. 9a and 9b continues similarly until all queues 961 have credit values 962 that are negative. At this point, in an embodiment, the system points to the next port with its set of queues. In an embodiment, data transfer from the queues of the next port is scheduled similarly. As stated above, once each queue of a given port has a negative credit, the next port is looked to, following a port scheduling scheme such as Weighted Round Robin (WRR).

Although several embodiments are specifically illustrated and described herein, it will be appreciated that modifications and variations of the present invention are covered by the above teachings and within the purview of the appended claims without departing from the spirit and intended scope of the invention.

1. A method for data transfer scheduling comprising:
providing a plurality of queues, each queue including a number of data sets, and each queue being associated to a credit counter having an initial value and a current value;
providing a pointer to indicate a proximate queue of the plurality of queues for data transfer; and
if the current value of said proximate queue meets a credit requirement, transferring a data set from said proximate queue to a receiving agent and altering the current value of said credit counter by an amount associated to a size of said data set.

2. The method of claim 1, wherein each queue follows a First In, First Out (FIFO) egress priority scheme.

3. The method of claim 1, wherein said transferring a data set is transferring a data set stored in local memory.

4. The method of claim 1, wherein said providing a pointer is to indicate a proximate queue of the plurality of queues for data transfer according to round robin scheduling.

5. The method of claim 1, wherein said initial value is a positive value and said current value is altered an amount of time after data transfer by deducting the size of said data set from the current value of said credit counter.

6. The method of claim 5, wherein the current value of said proximate queue meets the credit requirement if said current value is a non-negative number.

7. The method of claim 6, wherein the initial value is at least a maximum size for any data set of the plurality.

8. The method of claim 7, wherein the data set is an Internet Protocol (IP) packet.

9. The method of claim 7, wherein the plurality of queues is associated to a network processor.

10. The method of claim 7, wherein said plurality of queues is associated to a virtual port of a plurality of ports and data transfer occurs by said port until the credit counter of each queue of said port has a negative current value.

11. The method of claim 7, wherein said plurality of queues is associated to a virtual port of a plurality of ports and data transfer occurs by said port until the credit counter of said proximate queue has a negative current value.

12. The method of claim 10, wherein said data transfer occurs by no more than one port at a time according to a port scheduling protocol.

13. The method of claim 12, wherein said port scheduling protocol is Weighted Round Robin (WRR).

14. A system for data transfer scheduling comprising:
a plurality of queues, each queue including a number of data sets and each queue being associated to a credit counter having an initial value and a current value; and
a pointer to indicate a proximate queue of the plurality of queues for data transfer, wherein
if the current value of said proximate queue meets a credit requirement, a data set is transferred from said proximate queue to a receiving agent and the current value of said credit counter is altered by an amount associated to a size of said data set.

15. The system of claim 14, wherein each queue follows a First In, First Out (FIFO) egress priority scheme.

16. The system of claim 14, wherein said data set is transferred from local memory.

17. The system of claim 14, wherein said pointer is to indicate a proximate queue of the plurality of queues for data transfer according to round robin scheduling.

18. The system of claim 14, wherein said initial value is a positive value and said current value is altered an amount of time after data transfer by deducting the size of said data set from the current value of said credit counter.

19. The system of claim 15, wherein the current value of said proximate queue meets the credit requirement if said current value is a non-negative number.

20. The system of claim 19, wherein the initial value is at least a maximum size for any data set of the plurality.

21. The system of claim 20, wherein the data set is an Internet Protocol (IP) packet.

22. The system of claim 20, wherein the plurality of queues is associated to a network processor.

23. The system of claim 20, wherein said plurality of queues is associated to a virtual port of a plurality of ports and data transfer occurs by said port until the credit counter of each queue of said port has a negative current value.

24. The system of claim 20, wherein said plurality of queues is associated to a virtual port of a plurality of ports and data transfer occurs by said port until the credit counter of said proximate queue has a negative current value.

25. The system of claim 23, wherein said port scheduling protocol is Weighted Round Robin (WRR).

26. A set of instructions residing in a storage medium, said set of instructions capable of being executed by a processor to schedule data transfer comprising:
providing a plurality of queues, each queue including a number of data sets, and each queue being associated to a credit counter having an initial value and a current value;
providing a pointer to indicate a proximate queue of the plurality of queues for data transfer; and
if the current value of said proximate queue meets a credit requirement, transferring a data set from said proximate queue to a receiving agent and altering the current value of said credit counter by an amount associated to a size of said data set.

27. The set of instructions of claim 26, wherein each queue follows a First In, First Out (FIFO) egress priority scheme and said providing a pointer is to indicate a proximate queue of the plurality of queues for data transfer according to round robin scheduling.

28. The set of instructions of claim 26, wherein said transferring a data set is transferring a data set stored in local memory and the plurality of queues is associated to a network processor.

29. The set of instructions of claim 26, wherein said initial value is a positive value and said current value is altered an amount of time after data transfer by deducting the size of said data set from the current value of said credit counter.

30. The set of instructions of claim 29, wherein the current value of said proximate queue meets the credit requirement if said current value is a non-negative number and the initial value is at least a maximum size for any data set of the plurality.

31. A system for data transfer scheduling comprising:
a line card including one of a plurality of queues and coupled to a network via a media interface, each queue including a number of data sets and each queue being associated to a credit counter having an initial value and a current value; and
a pointer to indicate a proximate queue of the plurality of queues for data transfer, wherein
if the current value of said proximate queue meets a credit requirement, a data set is transferred from said proximate queue to a receiving agent and the current value of said credit counter is altered by an amount associated to a size of said data set.

32. The system of claim 31, wherein each queue follows a First In, First Out (FIFO) egress priority scheme and said data set is transferred from local memory.

33. The system of claim 31, wherein said initial value is a positive value and said current value is altered an amount of time after data transfer by deducting the size of said data set from the current value of said credit counter.

34. The system of claim 33, wherein the current value of said proximate queue meets the credit requirement if said current value is a non-negative number.
